(19) United States
(12) Patent Application Publication
(10) Pub. No.: US 2007/0002922 A1
(43) Pub. Date: Jan. 4, 2007

(54) Retro-reflecting lens for external cavity optics

(75) Inventor: Mark E. McDonald, Milpitas, CA (US)

Correspondence Address: MARSHALL, GERSTEIN & BORUN LLP (INTEL), 233 S. WACKER DRIVE, 6300 SEARS TOWER, CHICAGO, IL, 60606, US

(73) Assignee: INTEL CORPORATION, Santa Clara, CA (US)

(21) Appl. No.: 11/170,931

(22) Filed: Jun. 30, 2005

(51) Int. Cl. H01S 3/08

(52) U.S. Cl. 372/92

(57) ABSTRACT

An improved external cavity laser apparatus is disclosed whereby instead of a collimated beam being aligned with a flat mirror, the collimated beam is directed at a retro-reflecting lens. The front of the lens includes a focusing lens function and a rear of the lens is coated with reflective material. The collimated beam is then focused at the rear of the lens where it is reflected back towards the tuning elements, collimating lens and gain medium of the external cavity laser. Alignment tolerances for the retro-reflecting lens are greatly relaxed as compared to a flat mirror device. As a result, manufacturing external cavity lasers is facilitated, tooling costs are reduced and throughput is increased and reliability of the resulting device is increased as misalignment during the useful life of the resulting device is reduced or eliminated.

### BACKGROUND

1. Technical Field

Retro-reflecting lenses are shown and described. The disclosed retro-reflecting lenses are particularly useful as a substitute for conventional back cavity mirrors in external cavity diode lasers (ECDLs). The disclosed lenses facilitate ECDL construction as they require less rigid alignment tolerances than conventional flat mirrors.

2. Description of the Related Art

The demand for increased bandwidth in fiberoptic telecommunications has driven the development of sophisticated transmitter lasers suitable for dense wavelength division multiplexing (DWDM) that require the concurrent propagation multiple separate data streams through a single optical fiber. Each data stream is created by the modulated output of a semiconductor laser at a specific channel frequency or wavelength. The multiple modulated outputs are combined onto the single fiber.

The International Telecommunications Union (ITU) presently requires channel separations of approximately 0.4 nanometers, or about 50 GHz, which allows up to 128 channels to be carried by a single fiber within the bandwidth range of currently available fibers and fiber amplifiers. Greater bandwidth requirements will likely result in smaller channel separations in the future.

DWDM systems for telecommunications have largely been based on distributed feedback (DFB) lasers. DFB lasers are stabilized by a non-adjustable wavelength selective grating. Unfortunately, statistical variations associated with the manufacture of individual DFB lasers results in a distribution of wavelength channel centers. Hence, to meet the demands for operation, and temperature sensitivity during operation, on the fixed grid of telecom wavelengths complying with the ITU grid, DFBs have been augmented by external reference etalons or filters and require feedback control loops. Variations in DFB operating temperatures permit a range of operating wavelengths enabling servo control. However, conflicting demands for high optical power, long lifetime, and low electrical power dissipation have prevented use of DFB's in applications that require more than a single channel or a small number of adjacent channels.

Continuously tunable external cavity lasers (ECL) have been developed to overcome the limitations of individual DFB devices. Many laser tuning mechanisms have been developed to provide external cavity wavelength selection, such as mechanically tuned gratings used in transmission and reflection. External cavity laser tuning must be able to provide a stable, single mode output at a selected wavelength while effectively suppressing lasing associated with external cavity modes that are within the gain bandwidth of the cavity. Achieving these goals typically has resulted in increased, size, cost, complexity and sensitivity in tunable external cavity lasers or external cavity diode lasers (ECDL).

The advent of continuously tunable telecommunication lasers has introduced additional complexity to telecommunication transmission systems. Particularly, the tuning aspects of such lasers involve multiple optical surfaces that are sensitive to contamination and degradation during use. While the tuning of Vernier etalon pair filters using temperature control has been disclosed by the assignee of the present application in U.S. Pat. Nos. 6,853,654, 6,667,998 and elsewhere, certain problems regarding the manufacture of ECDL devices still exist.

Specifically, the cavity portion of an ECDL typically includes a collimating lens which directs the light from the gain medium towards a pair of filters, normally Vernier etalon filter elements, that are also tunable using heating elements or other electromechanical mechanisms. The tuning of the etalon pair allows wavelength selection. The collimated optical path is then reflected off of an end mirror back through the etalons and colliinating lens to the gain medium. As a result, precise alignment of the end mirror is required to accurately reflect the collimated optical path of the light back through the etalon filters and towards the gain medium.

The angular tolerance for such an end mirror or external cavity mirror is typically in the order of 1/100 of the ratio of the wavelength to beam diameter, or typically about 40 micro-radians. This narrow tolerance is problematic as it results in defective products and increased costs due to the alignment problems posed by the restrictive tolerance. Further, this alignment problem is exacerbated over the working life of the product, particularly if the ECDL is used in harsh ambient environments with significant temperature variations that can result in future misalignment of the end mirror. Hence, not only is alignment of the end mirror during manufacturing a problem, alignment of the end mirror during the useful like of the product is also a problem.

As a result, there is a need for an improved ECDL design with an improved end mirror or back cavity mirror device that is easier to align, that is less sensitive to alignment shifts during use of the ECDL thereby resulting in ECDLs that are less costly to manufacture and less likely to fail during use.

### BRIEF DESCRIPTION OF THE DRAWINGS

This disclosure will be more fully understood by reference to the accompanying drawings, which are provided for illustrative purposes only.

FIG. 1A is a side plan view of a retro-reflective, refractive lens made lithographically from a substrate in accordance with this disclosure;

FIG. 1B is a side plan view of another retro-reflective lens with a diffractive profile;

FIG. 1C is a side plan view of an alternative spherical retro-reflective lens made from a material having an index of refraction of about 2 and with a rear hemisphere being coated with a reflective material;

FIG. D is a side plan view of yet another retro-reflective lens made from a material also having an index of refraction of about 2 and having a semi-spherical configuration; and

FIG. 2 is a schematic illustration of a tunable ECDL device incorporating a retro-reflective lens made in accordance with this disclosure as well as an output side of the gain medium.

The drawings are not necessarily to scale and the embodiments have been illustrated with diagrammatic representations and fragmentary views. Certain details may have been omitted which are not necessary for an understanding of the disclosed embodiments or which render other details difficult to perceive. It should be understood, of course, that this disclosure is not limited to the particular embodiments illustrated in the drawings.

### DETAILED DESCRIPTION OF THE PRESENTLY PREFERRED EMBODIMENTS

It will be appreciated that the disclosed apparatuses may vary as to configuration and as to details of the parts, and that the disclosed methods may vary as to details and the order of the acts, without departing from the basic concepts as disclosed herein. While the disclosed retro-reflective lenses are explained primarily in terms of use with an external cavity laser, the disclosed retro-reflective lens may be used with various types of laser devices and optical systems. It should also be understood that the terminology used herein is for the purpose of describing particular embodiments only, and is not intended to be limiting, as the scope of this disclosure will be limited only by the appended claims. The relative sizes of components and distances therebetween as shown in the drawings are in many instances exaggerated for reason of clarity, and should also not be considered limiting.

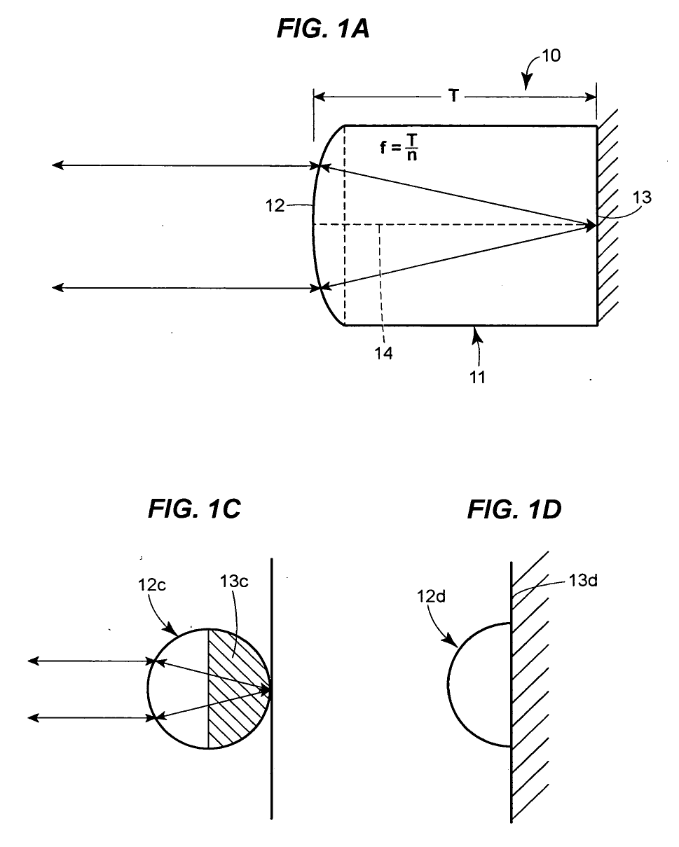

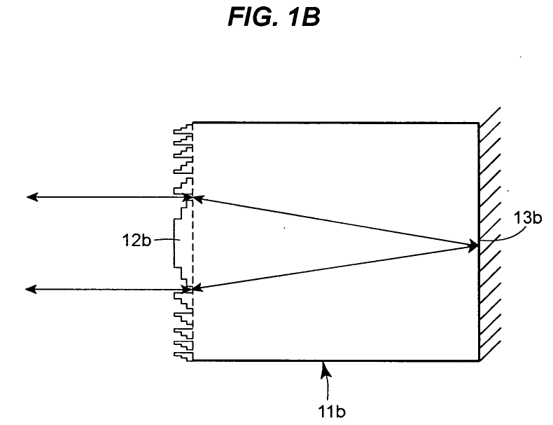

Referring now to FIG. 1A, a retro-reflective lens 10 is disclosed that is made from a substrate 11. The substrate 11 includes a front side 12 and a rear side 13. Preferably, the rear side 13 is coated with a reflective material so it acts as a mirror. The front side 12 of the substrate 11 is formed to serve as a lens. In a preferred embodiment, the lens 12 of the substrate 11 is formed lithographically.

Specifically, the substrate 11 can be polished to a desired thickness T using conventional technologies, such as chemical mechanical polishing (CMP). Then, the lens 12 can be formed lithographically. A round portion of the substrate 111 is covered with protective patterns, such as a photoresist pattern that is thicker along the center line 14 and which gets thinner as the mask extends away from the centerline. Thus, the outer portions of the lens 12 are etched faster than the center portion along the centerline 14 which is covered by a thicker mask patterns. In addition, small lenslets may be patterned over the area 12 shown as the lens in FIG. 1A which may result in the lens 12 having a stair-step construction. The finished rounded convex shape may also be obtained using polishing processes.

Further, the lens 12 can be etched to obtain a diffractive lens profile, or lens having a saw tooth pattern as shown in FIG. 1B. In FIG. 1B, a diffractive lens is illustrated with a convex central lens portion 12b FIG. 1C illustrates an alternative embodiment whereby the lens 12c is fabricated from a sphere of a material having an index of refraction of about 2. One suitable material is sold under the trademark LASF39™ by Deposition Sciences, Inc. of Santa Rosa, Calif. (http://www.depsci.com). Further, Deposition Sciences also makes ball lenses made of such materials and therefore the lens 12c can be purchased off of the shelf. An anti-reflective coating 13c is coated on one hemisphere of the lens 12c. Also, a semi-spherical lens 12e can be mounted to a surface 13e coated with reflective material as shown in FIG. 1D. Again, the material from which the lens 12d is fabricated should have a refractive index of about 2.

Other technologies for the lenses 12 include, but are not limited to, GRIN lenses and molded lenses. A GRIN lens mounted to the front of a substrate would be more costly while a molded lens on the front of a substrate would be less accurate.

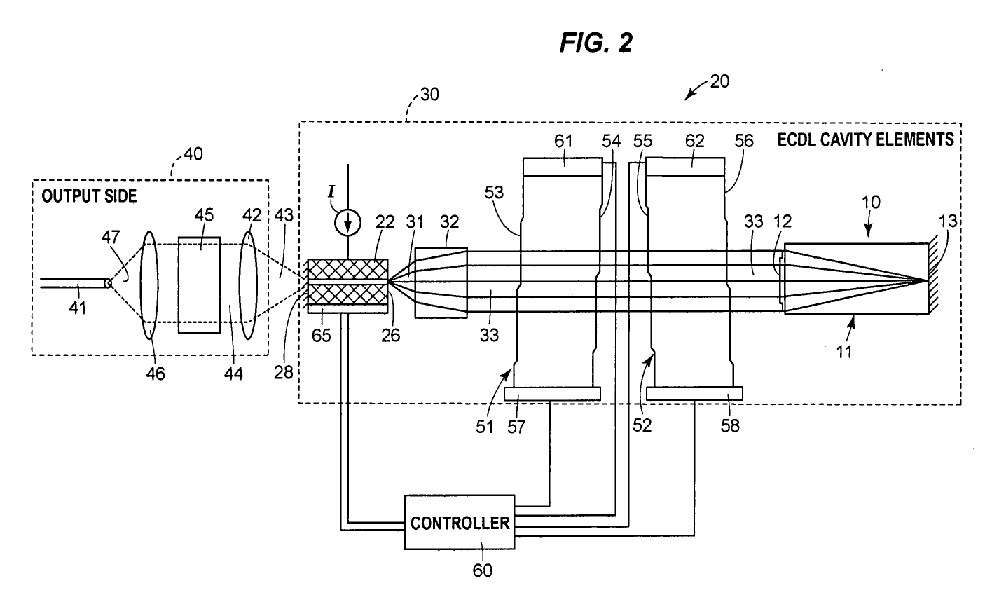

Turning to FIG. 2, a laser apparatus 20 is shown which includes a gain medium 22 and an end or external reflective element in the form of a disclosed retro-reflective lens 10. Gain medium 22 may comprise a conventional Fabry-Perot diode emitter chip and has an anti-reflection (AR) coated front facet 26 and a reflective or partially reflective rear facet 28. An external laser cavity 30 is delineated by rear facet 28 and the retro-reflective lens 10. Gain medium 22 emits a coherent light beam 31 from front facet 26 that is collimated by lens 32 to define an optical path 33.

Conventional output coupler optics are shown at 40 for coupling output from the rear facet 28 of the gain medium 22 to the optical fiber shown at 41. Specifically, a collimating lens is shown at 42 to collimate the light beam 43 received from the gain medium 22 to define the optical path 44 which is directed into the optical isolator 45. The isolator 45 then directs the light to the focusing lens 46 which focuses an output optical beam 47 such that it is launched onto the fiber 41.

Returning to the ECDL portion 30 of FIG. 2, first and second tunable elements 51, 52 are positioned within the external cavity 30 defined by lens 10 and facet 28. Tunable elements 51, 52 are operable together to preferentially feed back light of a selected wavelength to the gain medium 22 during operation of the laser apparatus 20. For exemplary purposes, the tunable elements 51, 52 are shown in the form of first and second tunable Fabry-Perot etalons, which may comprise parallel plate solid, liquid or gas spaced etalons, and which may be tuned by precise dimensioning of the optical thickness or path length. In other embodiments, etalon 51 and/or etalon 52 may be replaced with a grating, an adjustable thin film interference filter, or other tunable element as described below. The first etalon 51 includes faces 53, 54 and has a first free spectral range FSR₁ , according to the spacing between faces 53, 54 and the refractive index (n) of the material of the etalon 51. The second etalon 52 includes faces 55, 56 and has a second free spectral range FSR₂ defined by to spacing between faces 55, 56 and the refractive index (n) of the material of the etalon 52. The etalons 51, 52 may comprise the same material or different materials with different refractive indices.

The etalons 51, 52 each are tunable by adjustment of their optical thickness, to provide for adjustment or tuning of FSR₁ and FSR₂, which in turn provides selective wavelength tuning for the laser apparatus 20 as described further below. Tuning of the etalons 51, 52 can involve adjustment of the distance between faces 53, 54 and 55, 56 and/or adjustment of the refractive index of the etalon material, and may be carried out using various techniques, including thermo-optic, electro-optic, acousto-optic and piezo-optic tuning to vary refractive index, as well as mechanical angle tuning and/or thermal tuning to vary the spacing of etalon faces. More than one such tuning effect may be applied simultaneously to one or both etalons 51, 52.

In the embodiment shown in FIG. 2, the first and second etalons 51, 52 each are thermo-optically tunable. The term “thermo-optic” tuning means tuning by temperature-induced change in etalon material refractive index, temperature induced change in the physical thickness of an etalon, or both. The etalon materials used in certain embodiments have temperature dependent refractive indices as well as coefficients of thermal expansion such that thermo-optic tuning involves simultaneous thermal control of etalon material refractive index as well as thermal control of etalon physical thickness by selective heating or cooling. The selection of etalon materials for effective thermo-optic tuning are known to those skilled in the art and can be found in U.S. Pat. Nos. 6,853,654 and 6,667,998.

To provide thermo-optic tuning, a thermal control element 57 is operatively coupled to etalon 51, and a thermal control element 58 is operatively coupled to etalon 52, to provide heating and cooling to etalons via thermal conduction. Thermal control elements 57, 58 in turn are operatively coupled to a controller 60. The controller 60 may comprise a conventional data processor, and provides tuning signals to thermal control elements 57, 58 for thermal adjustment or tuning of the etalons 51, 52 according to selectable wavelength information stored in a look-up table or other wavelength selection criteria. The etalons 51, 52 also include temperature monitoring elements 61, 62 operatively coupled to controller 60 so that it can monitor etalon temperature during laser operation and communicate etalon temperature information to controller 60. Each thermal control element 57, 58 include a heating element (not shown) that allows adjustment of etalon temperature according to instructions from controller 60.

The thermal control of the etalons 51, 52 by thermal control elements 57, 58 may be achieved by conduction, convection or both. In many embodiments, thermal conduction is the dominant pathway for heat flow and temperature adjustment of etalons 51, 52 and convective effects, which may result in unwanted or spurious thermal fluctuation in the etalons 51, 52, should be suppressed. The external cavity laser apparatus 20 may be designed or otherwise configured to allow or compensate for the effects of heat flow by thermal convection, over the operational temperature range of the laser. For example, the apparatus 20 may be configured to restrict air flow near etalons 51, 52. In other embodiments, etalons 51, 52 may be individually isolated in low conductivity atmospheres or in a vacuum. Large air paths to structures of dissimilar temperature that are near to etalons 51, 52 and the use of thermally insulating materials for components that are proximate to etalons 51, 52 can also be used to suppress unwanted heat transfer to or from etalons. The design of the apparatus 20 may additionally be configured to provide laminar air or atmosphere flow proximate to etalons, which avoids potentially deleterious thermal effects associated with turbulence.

The etalons 51, 52 may be structured and configured such that a single thermal control element or heat sink can simultaneously provide effective tuning of both etalons 51, 52. The etalons 51, 52 may be joined or related by a sub-assembly (not shown) in which the etalons 51, 52 are positioned or angled with respect to each other in a manner that avoids unwanted optical coupling between the etalons 51, 52. The mounting of the etalons 51, 52 with materials of suitable thermal properties can prevent undesired thermal coupling between the etalons 51, 52 during tuning.

Facets 26, 28 of the gain medium 12 also define a Fabry-Perot etalon, and a thermal control element 65 is operatively coupled to gain medium 22 to thermally stabilize the distance between facets 26, 28 and provide for stable output from gain medium 22. The thermal control element 65 is also operatively coupled to controller 60 as shown in FIG. 2.

In the operation of the apparatus 20, a light beam 31 exits facet 26 of the gain medium 22, passes through etalons 51, 52, reflects off the retro-reflective lens 10 and returns through etalons 51, 52 to gain medium 22. The difference in free spectral range of the etalons 51, 52 results in a single, joint transmission peak defined by the etalons 51, 52 and light at the wavelength of the joint transmission peak is fed back or returned to gain medium 22 from the etalons 51, 52 to provide lasing of the apparatus 20 at the joint transmission peak wavelength.

Tuning of the joint transmission peak of etalons 51, 52 during the operation of laser apparatus 20 may be carried out according to a particular set of communication channels, such as the International Telecommunications Union (ITU) communication grid. A wavelength reference (not shown), such as a grid generator or other wavelength reference, may be used in association with the apparatus 20, and may located internally or externally with respect to the external cavity 30 of apparatus 20 DWDM systems, however, are increasingly dynamic or re-configurable in nature, and the operation of tunable external cavity lasers according to a fixed wavelength grid is increasingly less desirable. The disclosed laser apparatus 20 can provide continuous, selective wavelength tuning over a wide wavelength range in a manner that is independent of a fixed, pre-determined wavelength grid, and thus allows for rapid re-configuration of DWDM systems.

The use of dual thermo-optically tuned etalons 51, 52 for wavelength selection in the external cavity laser 20 eliminates the need for mechanical tuning as is in grating tuned external cavity lasers. The thermo-optic tuning is solid state in nature and allows a more compact implementation than is possible in grating tuned lasers, with faster tuning or response times, better resistance to shock and vibration, and increased mode-coupling efficiency. Simultaneous tuning of dual tunable etalons provides more effective laser tuning than can be achieved by the use of a single tunable etalon together with a static etalon.

Semiconductor materials, such as Si, Ge and GaAs, exhibit relatively high refractive indices, high temperature sensitivity of refractive index, and high thermal diffusivity, and thus provide good etalon materials for thermo-optically tunable embodiments of the invention. Many microfabrication techniques are available for semiconductor materials, and the use of semiconductor etalon materials also allows integration of thermal control and other electrical functions directly onto the etalons, which provides greater tuning accuracy, reduced power consumption, fewer assembly operations, and more compact implementations. Silicon as an etalon material is noteworthy, with a refractive index of approximately 3.478 and a coefficient of thermal expansion (CTE) of approximately 2.62×10⁻⁶/° K. at ambient temperatures. Silicon is dispersive and has a group refractive index n_{g}=3.607. There also exists a great deal of silicon processing technology that allows integration of thermal control elements directly onto or within a silicon etalon, as described further below.

As opposed to a simple mirror reflective element at the opposite end of the external cavity 30 from the gain medium 22, the disclosed apparatus 20 incorporates the retro-reflecting lens 10. The lens 10 provides distinct advantages over a simple mirror element. Specifically, a precise alignment with the optical path 33 is not necessary as the lens element on the front face of the substrate 11 acts to focus the light towards the rear face 13 as shown in FIGS. 1A-1E and 2. This reduces the precise alignment between a reflective surface and the optical path 33.

For example, the angular tolerance provided by the retro-reflecting lens 10 is greatly relaxed as compared to a prior art flat mirror device. Specifically, the angular tolerance for an external cavity flat mirror is typically on the order of 0.01 times the wavelength divided by the beam diameter resulting in a net tolerance of about 40 micro radiance when the wavelength is 1.55 microns and the beam diameter is 400 microns. The disclosed retro-reflector 10 has an angular tolerance of 0.01 times the beam diameter divided by two times the focal lengths with a net angular tolerance of about 1,000 micro radiance for a beam diameter of 400 microns and a focal length of about 2 mm. This wider tolerance permits significantly simpler alignment methods in the assembly of the external cavity laser 20 thereby reducing costs and increasing productivity. Tooling costs may also be reduced.

While only certain embodiments have been set forth, alternative embodiments and various modifications will be apparent from the above description to those skilled in the art. These and other alternatives are considered equivalents and within the spirit and scope of this disclosure.

What is claimed is:

1. A retro-reflecting lens comprising:
a substrate comprising a front and a rear,
the rear being coated with or engaging a layer of reflective material,
the front comprising a lens for focusing light passing through the lens and into the substrate against the rear.

2. The retro-reflecting lens of claim 1 wherein the lens is formed lithographically from a substrate.

3. The retro-reflecting lens of claim 2 wherein a thickness of the substrate between the lens and the rear is controlled lithographically and by polishing the lens and front face.

4. The retro-reflecting lens of claim 3 wherein the polishing is chemical mechanical polishing (CMP).

5. The retro-reflecting lens of claim 1 wherein the lens is convex and extends outward from the rear face of the substrate.

6. The retro-reflecting lens of claim 1 wherein the lens is spherical in shape and wherein the front of the lens is a front hemisphere and the rear of the lens is a rear hemisphere and further wherein the rear hemisphere is coated with a reflective material.

7. The retro-reflecting lens of claim 1 wherein the lens is semi-spherical in shape and the front of the lens is a hemisphere and the rear of the lens is planar and coated with a reflective material.

8. The retro-reflecting lens of claim 1 wherein the lens has a diffractive lens profile.

9. The retro-reflecting lens of claim 8 wherein a center portion of the lens is convex.

10. The retro-reflecting lens of claim 8 wherein a center portion of the lens is concave.

11. The retro-reflecting lens of claim 1 wherein the lens in a GRIN lens attached to the front of the substrate.

12. The retro-reflecting lens of claim 1 wherein the lens is molded onto the front of the substrate.

13. An external cavity laser comprising:
a gain medium directing light towards a collimating lens,
the collimating lens directing light towards a retro-reflecting lens,
the retro-reflecting lens comprising
a substrate a front and a rear,
the rear coated with or engaging a layer reflective material,
the front comprising a lens directed towards the gain medium for focusing light received from the gain medium against the rear.

14. The external cavity laser of claim 13 wherein the substrate is made of a material having an index of refraction and the light directed towards the retro-reflective lens has a frequency, and
wherein a working distance of the retro-reflective lens between the lens on the front face and a focal point on the rear face is a function of the index of refraction of the substrate and the frequency of the light passing through the retro-reflective lens.

15. The external cavity laser of claim 13 wherein the retro-reflecting lens is formed from a substrate having a thickness and the lens has a refractive profile.

16. The external cavity laser of claim 13 wherein the lens is a ball lens wherein the front of the lens is a front hemisphere and the rear is a rear hemisphere coated with a reflective material.

17. The external cavity laser of claim 13 wherein the lens is a hemispherical lens and wherein the front is a front hemisphere and wherein the rear is a planar surface coated with or engaging the reflective material.

18. The external cavity laser of claim 13 wherein the lens has a diffractive profile.

19. A method of manufacturing a retro-reflective lens, the method comprising:
providing a substrate and a front face and a rear face,
polishing at least one of the front and rear faces of the substrate to obtain a first preliminary thickness, and
lithographically etching a convex lens onto the front face.

20. The method of claim 19 wherein the polishing and the lithographically etching provides a working distance of the retro-reflective lens between the convex lens on the front face and a focal point on the rear face as a function of an index of refraction of a material from which the substrate is made and a frequency of light passing through the retro-reflective lens.
